(19) United States
(12) Patent Application Publication
(10) Pub. No.: US 2009/0201223 A1
(43) Pub. Date: Aug. 13, 2009

(54) ELECTRONIC BOOK

(76) Inventor: Blake Stephens, Laguna Niguel, CA (US)

Correspondence Address: Kenton R. Mullins;Stout, Uxa, Buyan & Mullins, LLP, Suite 300, 4 Venture, Irvine, CA, 92618, US

(21) Appl. No.: 12/368,300

(22) Filed: Feb. 9, 2009

Related U.S. Application Data
(60) Provisional application No. 61/027,413, filed on Feb. 8, 2008.

(51) Int. Cl. G09G 5/00

(52) U.S. Cl. 345/1.3

(57) ABSTRACT

A compact folding electronic book 10 is described having two individual screens configured to appear as an open book. Advanced features include a retractable photovoltaic panel.

### CROSS-REFERENCE TO RELATED APPLICATIONS

This application claims the benefit of U.S. Provisional Application No. 61/027,413, filed Feb. 8, 2008 and entitled ELECTRONIC BOOK, the entire contents of which are hereby incorporated by reference.

### BACKGROUND OF THE INVENTION

1. Field of the Invention

The present invention relates generally to electronic devices and, more particularly, to hand-held electronic books.

2. Description of Related Art

Electronic books are known that permit a user to download and read text on the go. However, these known devices are quite limited in their capability.

A need thus exists in the prior art for an electronic book having advanced capabilities.

### SUMMARY OF THE INVENTION

The present invention addresses these needs by providing a hand-held electronic platform for knowledge and education. The invention herein disclosed comprises two individual screens joined by hinges and configured to be closed or opened, whereby the platform has an appearance of a library bound book when closed. When opened, the two individual screens have an appearance of pages of an open book. An embodiment of the platform further comprises buttons on the two individual screens, the buttons being configured to control an appearance of text on the screens. Another embodiment of the platform even further comprises a foldable, retractable photovoltaic panel adapted to supply electrical power to the platform.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

Any feature or combination of features described or referenced herein are included within the scope of the present invention provided that the features included in any such combination are not mutually inconsistent as will be apparent from the context, this specification, and the knowledge of one skilled in the art. In addition, any feature or combination of features may be specifically excluded from any embodiment of the present invention. For purposes of summarizing the present invention, certain aspects, advantages and novel features of the present invention are described. Of course, it is to be understood that not necessarily all such aspects, advantages or features will be embodied in any particular implementation of the present invention. Additional advantages and aspects of the present invention are apparent in the following detailed description and claims that follow.

### BRIEF DESCRIPTION OF THE FIGURES

FIG. 1 is a diagram illustrating an appearance of a compact, folding electronic book in a closed configuration;

FIG. 2 is a diagram depicting an embodiment of the hand-held electronic book of FIG. 1 in an open configuration and illustrating two side-by-side screens;

FIG. 3 is a diagram showing an electronic book having a foldout photovoltaic panel; and

FIG. 4 is a pictorial diagram of another embodiment of the electronic book showing a slide-out, hinged book light/sunshade and a slide-out, hinged rotating keyboard/bookstand.

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not presumed, automatically, to be to precise scale in all embodiments. That is, they are intended to be examples of implementations of various aspects of the present invention and, according to certain but not all embodiments, to be to scale. While, according to certain implementations, the structures depicted in these figures are to be interpreted to be to scale, in other implementations the same structures should not. In certain aspects of the invention, use of the same reference designator numbers in the drawings and the following description is intended to refer to similar or analogous, but not necessarily the same, components and elements. According to other aspects, use of the same reference designator numbers in these drawings and the following description is intended to be interpreted as referring to the same or substantially the same, and/or functionally the same, components and elements. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent accompanying this disclosure is to discuss exemplary embodiments with the following detailed description being construed to cover all modifications, alternatives, and equivalents of the embodiments as may fall within the spirit and scope of the invention as defined by the appended claims. It is to be understood and appreciated that the process steps and structures described herein do not cover a complete process flow for the manufacture of the disclosed structures. The present invention may be practiced in conjunction with various electronic device fabrication and other techniques that are conventionally used in the art, and only so much of the commonly practiced process steps are included herein as are necessary to provide an understanding of the present invention. The present invention has applicability in the field of electronic devices in general. For illustrative purposes, however, the following description pertains to an electronic book having advanced features.

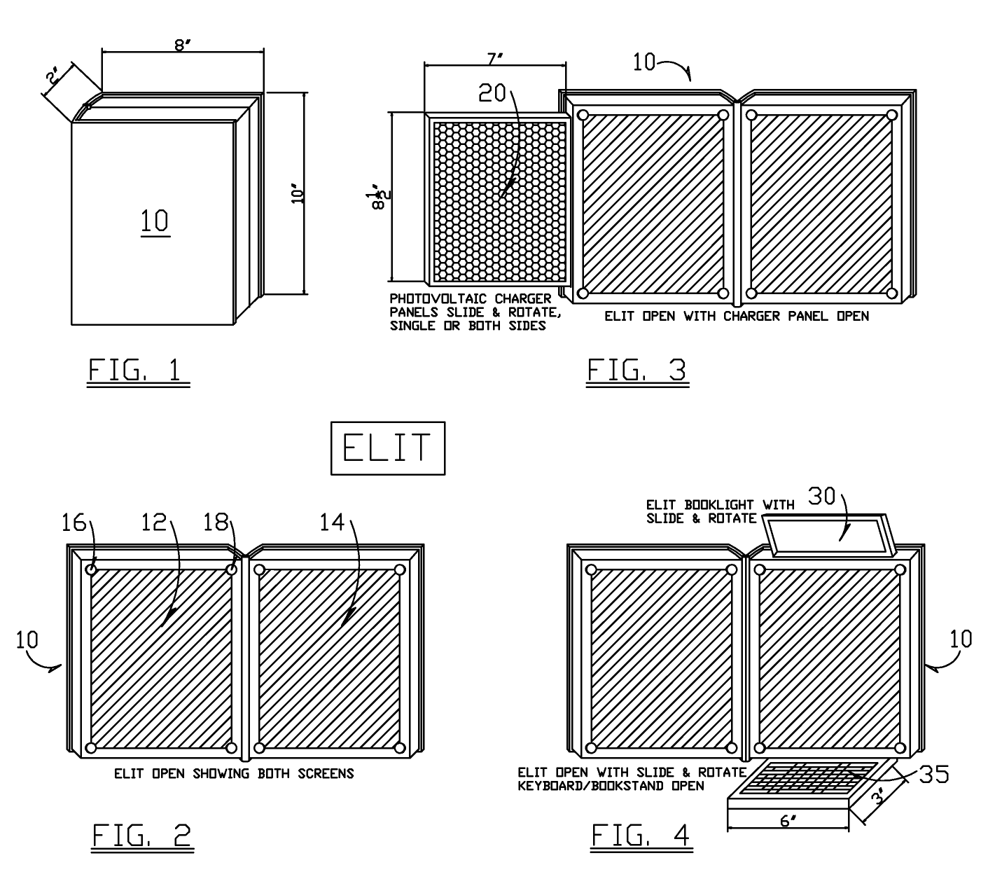

Referring more particularly to the drawings, FIG. 1 is a diagram illustrating an appearance of a compact, folding, hand-held electronic platform for knowledge and education, e.g., an electronic book 10, in a closed configuration. Rechargeable batteries, e.g., interchangeable battery packs, may be included with the platform, which may have a capability of receiving AC power from a common electrical outlet. The platform may have an appearance of a library bound book when closed and may open to provide visual access to two side-by-side individual screens joined by a rotating hinge, the screens being configured to display images similar to those available in pages of a common library book. The electronic book 10 may be configured to contain a relatively large memory capable of providing a library of materials, for example, encyclopedia, dictionary, thesaurus, and reference books in a hand-held package.

Multiple and interchangeable exterior covers (bindings) may be used to allow customization for education/collegiate users, business and professional users, low-cost and luxury users. For example, a leather or simulated leather cover may be used based on a choice of an end user. An embodiment of the electronic book 10 may appear similar to a classical collector's edition book, for example.

Implementations of the electronic book 10 may be designed to be water-resistant and/or completely waterproof. Fail-safe shut-off and restart capability is a feature. Additionally, the electronic book 10 is implemented with an internal foam gel shock absorber and heat sink layer and/or gyroscope to buffer substantial abuse, impacts, shock and extremes of cold and heat. Typical embodiments are fabricated of recyclable materials and comprise detachable components for ease in recycling. A recycling deposit may be included in a purchase price of the electronic book 10 in order to ensure its re-use.

FIG. 2 is a diagram depicting an embodiment of the hand-held electronic platform or electronic book 10 in an open configuration illustrating the two side-by-side screens, e.g., a first screen 12 and a second screen 14 that are joined by a rotating hinge (not shown) as known and used in the context of notebook computers. Embodiments of the electronic book 10 may further comprise a plurality of buttons, e.g., four on each screen, two examples of which are designated as 16 and 18 in FIG. 2. The buttons may be configured to control aspects of operation of the electronic book 10. For example, one or more (e.g., each) of the buttons may permit (e.g., independently of or in a coordinated fashion with the other buttons) a user to perform one or more of: turn power on or off, advance to a next display in a sequence of displays (e.g., turn a page), advance to a previous display, release a photovoltaic panel, release a book light, release a sunshade, release a keyboard/bookstand, provide access to touch-screen control, control user security, control plug and play access and similar functions. The button(s), further, may provide a capability for a reader of the electronic book 10 to modify an appearance of text on the screens including, for example, an ability to highlight, italicize, and/or underline text. The buttons and screens, generally, provide an intuitive interface that permits users of various ages, abilities, and experience to adapt easily to use of the electronic book 10. Lifelong continuing education integrated with media and entertainment along with the written language thereby can be fostered by way of use of the electronic book 10.

Embodiments of the platform may provide a capability for a user to annotate content displayed on the screens and/or to tag such annotations with a name of an individual who is making the annotations. Alternatively, the annotations may be tagged with a nickname of the user. One embodiment of the platform may allow a user to transfer a copy (e.g., email) of an annotated version of the content to one or more other individuals for review and/or comment. Digital rights may be secured before emailing copyrighted materials. Optionally, an authoring capability may be provided to allow users to write or dictate their own work.

Other features may be provided by still other embodiments of the electronic book 10. For example, the electronic book 10 may provide a capability to choose font and text size according to visual acuity of a user. Other embodiments may have eyeglass and contact prescriptions integrated into the screens as a corrective visual element adapted to needs of a user. The electronic book 10 may provide user-selectable interfaces such as interchangeable hardwired and wireless communication interfaces that enable intercommunication with the Internet and/or public and/or private communication systems. Cell phone access as well as access using developing communication devices is available in an option in some embodiments. Such communication access may permit virtually any type of content to be downloaded to the electronic book 10, thereby obviating a need for paper-based publishing. For example, visual media such as web TV, movies, instructional films and the like may be made available to users and may be displayed separately (e.g., different image(s) on the two pages) or in a coordinated fashion (e.g., an image spanning both pages) on one or both pages of the electronic book 10. An additional interface may be provided for any industry standard printer/scanner/fax system that may attach (e.g., via hardwiring or wirelessly) and integrate to a rear cover of the electronic book 10 using a stored or sheet fed paper supply. As another example, electronic content in text and/or audio format may be downloaded from public or private networks, a specific intranet, library, or the like. Wireless headphones may be included in some embodiments, the headphones being keyed to public space sensors in order to mute sound generation and to avoid nuisance. Daily, weekly, and monthly subscriptions of periodicals may be automatically downloaded from an Internet connection. In fact, the electronic book 10 provides an opportunity for users to receive free and subscription, daily and periodical literature. The electronic book 10 may be configured to allow students enrolled in elementary and secondary schools as well as colleges to download textbooks, so that a student would need to carry only one device, the electronic book 10, to class rather than a collection of paper-based books. The electronic book 10 thereby may provide standard and customized textbooks for a variety of levels of education in a single package. Tutoring and study programs may be provided by the electronic book 10 in order to tutor students and allow for curriculum focused study and test preparation. Additionally, the electronic book 10 may be self-tutoring for features included in the electronic book 10, and the device may provide continuing updates for a user.

Embodiments of the electronic book 10 may be private-labeled and branded by, for example, on-line and conventional bookstores who pre-program units of the electronic book 10 with unique pre-programmed features or pre-downloaded content. Similarly, on-line bookstores can establish their own differentiated download features or promotional benefits only available websites operated by the on-line bookstores. Conventional bookstores and libraries may continue to be public for a where owners of the electronic book 10 may gather to browse and download books with special book store electronic download features or promotional benefits only available at such bookstores.

Translation capabilities may be built-in to the electronic book 10 so that text can be translated into any language. In another mode of operation, each side of the book may display the same text in a different language.

Embodiments of the electronic book 10 may provide audio and/or text-to-speech capability for visually impaired users. Alternatively, audio books (such as, for example, books on tape) may be downloaded to the electronic book 10, which may allow a user, visually impaired or not, to listen to content using the electronic book 10. Implementations of the electronic book 10 may allow users to hear content spoken through a voice delivery system having multiple selections of language, voice tone and accent and/or dialect. The translation capabilities of the electronic book 10 may be combined with the audio capability in order that the electronic book 10 may act as a spoken word translator. Embodiments of the electronic book 10 may, further, include a voice recognition capability that allows hands free word processing and control of the electronic book 10. For example, a page-turning and/or scrolling command may be touch and/or voice activated. Other embodiments of the electronic book 10 may have plug and play elements to allow users to customize their electronic book 10 by simply plugging in an element to suit their needs and desires. Plug-in memory, battery power packs, specialized hardware, and enabling elements for disabled users or users with special needs can be implemented making them simple for a user to install and interchange.

It should be clear that any content appearing in a normal book, such as color photos, drawings, plans and illustrations may be provided by a system that includes the electronic book 10. Additionally, going beyond content that is available in normal books, the electronic book 10 can provide graphic programs, computer-aided design (cad) capabilities, drafting and/or visualization programs. Generally, the electronic book 10 may appear to be very simple in the context of use, for example, by very young and/or elderly users. However, the electronic book 10 has advanced capabilities disclosed herein that permit the electronic book 10 to meet the needs of any advanced technical user.

FIG. 3 is a diagram showing an embodiment of an electronic book 10 having a foldout (e.g., slide-out) photovoltaic panel 20 that, according to one exemplary application, may be configured to allow a user to recharge the batteries of the electronic book 10. Additionally, the photovoltaic panel 20 may be configured to contribute power to a public electric grid so that average power consumed by the platform over time may be zero or even negative. Alternatively, rechargeable battery packs may use only off-peak electricity, thereby reducing a cost of operation of the device and providing benefits to the environment as well.

An embodiment of the foldout photovoltaic panel 20 may comprise a rotating hinge that permits the photovoltaic panel to fold back over a cover of the electronic book 10 when the electronic book 10 is closed (cf. FIG. 1). For instance, the foldout photovoltaic panel 20 may have photovoltaic elements on both sides, thereby providing a capability to generate electricity both when the electronic book 10 is open and when it is closed.

FIG. 4 is a pictorial diagram of another embodiment of the electronic book 10 showing a slide-out, hinged book light/sunshade 30 and a slide-out hinged rotating keyboard/bookstand 35. The keyboard component of the keyboard/bookstand 35 may provide an ability for users to compose written work on, for example, one screen while reading or referring to material on the other screen of the electronic book 10. An internal on-screen keyboard may also be provided in some embodiments. The bookstand element of the keyboard/bookstand 35 may rotationally locked to permit the electronic book to rest on a desk during use. When retracted, the bookstand permits the electronic book 10 to be held like a book.

An aspect of the electronic book 10 includes a capability for a master user having a super password to control aspects of operation of the electronic book 10. For example, an embodiment of the electronic book 10 may include a global positioning system (GPS) locator feature so that the electronic book 10 may function as a normal GPS device in addition to proving an ability to locate the device in case of loss. Further, the electronic book 10 may be password, fingerprint and/or iris scan protected to eliminate an incentive for theft. The electronic book 10 may also provide the master user with a capability to monitor a present or past location of the electronic book 10 and with an ability to communicate with the electronic book 10 remotely using, for example, cellular telephone technology supported by the electronic book 10.

A filtering feature of the electronic book 10 may permit incorporation of parental controls and/or school/moral/religious standards in order to make the device friendly to child/adolescent/family users. Additionally, anti-plagiarism protection may be integrated into word processing capabilities provided by the electronic book 10. In case of industry rated downloadable materials, each electronic book 10 may provide an opportunity for the master user to program the device in order to limit downloaded content to certain rated digital materials and to reject materials having a non-approved rating. In this way, for example, parents or employers can ensure that the device is used only for intended purposes. Anther feature of the electronic book 10 provides the master user (using the super password) to monitor the location and activities of the electronic book 10 through the Internet. If appropriate, the master user can send digital (text, voice, and/or video) messages to a user of the electronic book 10. Embodiments of the electronic book 10 may include a camera adapted to record audio and video of live conversations. In other embodiments of the electronic book 10 the camera can be linked to the Internet to provide a capability for live face-to-face conversations with one or more other individuals on the Internet.

In view of the foregoing, it will be understood by those skilled in the art that the present invention can facilitate presentation of visual and auditory information in a wide variety of contexts. Benefits of the invention include obviating a use of paper in publishing of books. Both publisher and purchaser benefit from such a practice not to mention that billions of tons of paper now used in publishing books could be saved. Forest resources also could be redirected to manufacturing and fuel, rather than paper, production. Additionally, features included in the devices described herein may allow considerable interactivity, customization and flexibility for users of the devices. In particular, disabled users can have all manner of accommodation incorporated into the disclosed devices to provide greatly increased access to publications, learning, and knowledge. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A hand-held electronic platform for knowledge and education comprising:
two individual screens joined by hinges and configured to be closed or opened, whereby
the platform has an appearance of a library bound book when closed; and
the two individual screens have an appearance of pages of an open book when opened;
buttons on the two individual screens, the buttons being configured to control an appearance of text on the screens; and
a foldable, retractable photovoltaic panel adapted to supply electrical power to the platform.
